(19) United States
(12) Patent Application Publication
(10) Pub. No.: US 2013/0179033 A1
(43) Pub. Date: Jul. 11, 2013

(54) VEHICLE CONTROL CIRCUIT

(71) Applicant: Bruce Allen Williams, Farmington Hills, MI (US)

(72) Inventor: Bruce Allen Williams, Farmington Hills, MI (US)

(73) Assignee: Ford Global Technologies, LLC., Dearborn, MI (US)

(21) Appl. No.: 13/348,240

(22) Filed: Jan. 11, 2012

(51) Int. Cl. G06F 17/00

(52) U.S. Cl. 701/36

(57) ABSTRACT

A body control module (BCM) of a vehicle has an output bus which provides addressed control signals to a plurality of electrical control units (ECUs) coupled to the bus. The ECUs include a power control relay and an addressable control circuit which responds to an address uniquely identifying a particular ECU for actuating the associated relay to provide power to an electrical device in the vehicle. The control signals from the BCM can be any one of several data processing protocols, including local interconnect network (LIN), and controller area network (CAN) to provide the address and data for controlling each of the relays.

### FIELD OF THE INVENTION

The present invention relates to a control circuit for controlling vehicle relays and, particularly, a control circuit which interfaces with the Body Control Module (BCM) of a vehicle to provide operating power to multiple relays utilizing a common bus communication link.

### BACKGROUND OF THE INVENTION

Many vehicle peripheral devices, such as headlamps, power seats, power windows, heated seats, and the like, require the use of a relay to provide sufficient current for powering the device. Such devices are typically controlled by operator input switch functions, which switch information is coupled to an Electronic Control Unit (ECU), such as a body control module, which typically contains a microprocessor, which, in turn, activates a solid state switch, such as a metal-oxide-semiconductor field-effect transistor (MOSFET), to provide sufficient current to a relay coil activating the power supplying relay. The relay contacts couple power from the vehicle's battery bus line to the accessory being activated. The utilization of discreet solid state switches, which are coupled by conductors from an ECU, requires numerous electrical connections in the vehicle requiring a bundle of wires between the ECU and relays, typically to the engine compartment where the relays are located. This adds additional cost and weight to the automotive electrical system and is difficult to modify during the design of a particular vehicle model, particularly, where additional accessories are added late in the development process.

There exists a need, therefore, for an improved control system for devices requiring relatively high current loads that require relays to provide sufficient current to the device and which allows greater design flexibility while reducing the overall cost, weight, and complexity of the electrical control system for the vehicle.

### SUMMARY OF THE INVENTION

The system of the present invention provides such benefits by incorporating within, or in close association with each device relay, an addressable control circuit which receives an address and control command from a single bus coupled to an ECU, such as a Body Control Module and to each of the addressable circuits to be controlled. Any one of the popular automotive communication protocols can be used on a serial bus line, such as local interconnect network (LIN), controller area network (CAN) to provide the address and data for controlling each of the relays. Each relay includes its own control circuit which may include an application specific integrated circuit (ASIC) and a MOSFET driver coupled to the serial bus to receive a command control signal and provide current to the relay coil which responds to activate the relay contacts, providing power to a vehicle device or accessory.

A relay control circuit can be any type of electronic control circuit which includes a microprocessor or other programmable control device for actuating a solid state switch in response to an identified address and data control signal. In some embodiments, the relay control circuit can be embedded within the body of the relay housing itself. In other embodiments, the relay may be mounted on a circuit board which includes the associated control circuit. In either approach, the number of conductors required for coupling power control relays to the ECU is reduced to a minimum, typically with a single bus line providing address and control signals for numerous circuit control power relays.

These and other aspects, objects, and features of the present invention will be understood and appreciated by those skilled in the art upon studying the following specification, claims, and appended drawing.

### BRIEF DESCRIPTION OF DRAWINGS

In the drawing:

FIG. 1 is a block and schematic circuit diagram of the system embodying the present invention.

### DETAILED DESCRIPTION OF PREFERRED EMBODIMENTS

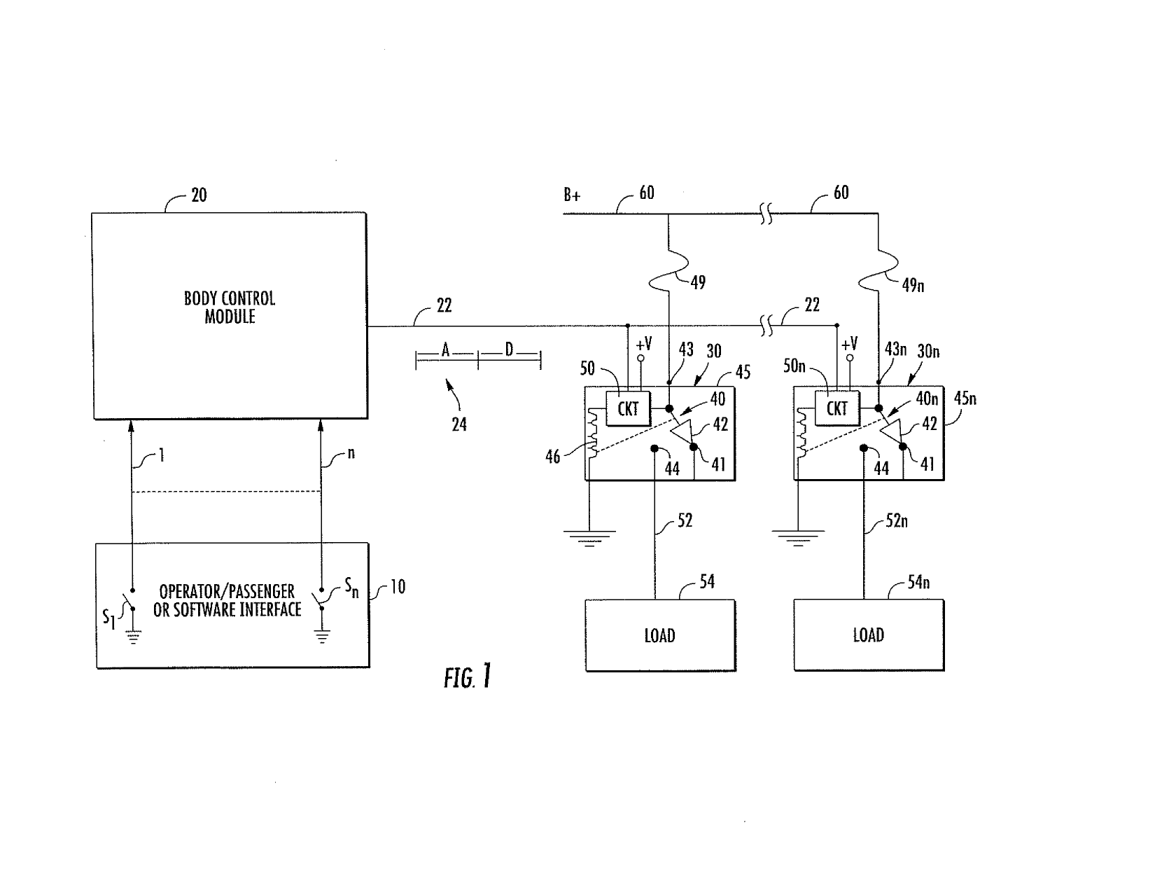

Referring to FIG. 1, there is shown a block and schematic diagram of the system embodying the present invention. A vehicle, such as an automobile, SUV, truck, or the like will include an operator/passenger/software interface 10 comprising a plurality of switches S₁-Sₙ coupled by conductors 1-n to a body control module 20. The switches are available to either the driver/operator or a passenger for controlling devices and accessories in the vehicle. Also, software for automatically controlling vehicle functions, such as an engine cooling fan, heater controls, and the like, can provide a control signal to the body control module 20. Powered devices and accessories include, for example, headlamps, power seat position controls, heated seat controls, door locks, window controls and the like. Each of these switches, variously located in the vehicle, are coupled by conductors 1-n to a body control module 20 to provide control signals thereto. Module 20 typically includes a microprocessor with suitable interface circuits which respond to signals on conductors 1-n to execute an addressed command on output bus 22 uniquely identifying the device or accessory to be controlled using a conventional protocol, such as LIN, CAN, Flexray, Ethernet, a commercially available OEM protocol (such as GM protocol), or the like. The body control module in one embodiment included a microprocessor, such as an MPC 560xB manufactured by Freescale Semiconductor Inc. and known in connection with the Ford Motor Company vehicles as the Bolero system.

Thus, for each switch activation in interface 10, an output signal on bus 22 will be generated, as indicated by the pictorial representation 24 of the output control signal. Signal 24 includes an address section identified by arrow A and at least a data section indicated by arrow D in the pictorial representation 24. Signal 24 includes the address A, which is typically referred to as a header including a synch break, synch field, and identification field. The data field includes the control signal and a check sum field for data checking accuracy. The LIN communication protocol is well known, as are the circuits employed using the protocol.

The unique control signals on buss 22 will identify one of the numerous electrical control units (ECUs) 30-30n for accessories and devices. Currently, typically up to sixteen electronic control units 30-30n can be coupled to bus 22 and employ the LIN protocol. Each of the electronic control units, such as 30, include a relay 40 having a movable contact 42 coupled to an input terminal 43, in turn, coupled to the vehicle power supply conduit 60 from the battery through a suitable fuse 49. Relay 40 also includes fixed contacts 41 and 44 and, when activated by control circuit 50, provides current to energize the relay coil 46, creating a magnetic field moving the movable metal contact 42 from an off position, as shown in FIG. 1, to contact 44. This applies power from conduit 60 through fuse 49 and conductor 52 to the load 54 which can be any number of relatively high current devices or accessories, such as headlights, a window control motor, door lock solenoids, resistance seat heaters, or the like.

Each control circuit 50-50n may include an application specific integrated circuit (ASIC, including a MOSFET) programmed to recognize the address on bus 22 identifying the specific associated load 54 which, when the identifying address is received together with a data command to activate the accessory, applies current to relay coil 46 to activate relay 40, thereby powering the associated load 54.

The control circuits 50-50n can likewise include a microprocessor, such as a Star 12 available from Freescale Semiconductor Inc., together with an output solid state switch or driver for supplying power to the relay coil 46 and, in turn, the load. Circuits 50-50n may be built into the casing 45 of the relays, such that it is integrated and embedded into the relays 40-40n, as graphically illustrated in FIG. 1, as a high side drive shown or alternately as a low side drive. Alternatively, relays 40-40n can be mounted on an integrated circuit board including circuit 50 and the relatively small relay. Each of the electronic controlled relays 30-30n are substantially identical, except control circuits 50-50n are each programmed with a unique address which uniquely identifies the associated load 54-54n. Thus, when an operator or passenger or computer software actuates a particular device or accessory control switch, the electronic controlled relays 30 associated with the particular switch will be activated to provide operating power to the load. The electronic controlled relays 30 provide two-way communication between them and an ECU 20, such that the status of the accessory being controlled is known by the ECU. Each of the control circuits 50 supply operating power through the normal solid state control power supply system (+V) for activation. Typically, the system shown in FIG. I also allows a sleep command to be sent along bus 22 when a vehicle is turned off to minimize current drain on the battery.

In addition to the LIN protocol, other protocols, such as the CAN protocol or the like, can be employed with the system of the present invention, it being understood that the ECU 20 will include a communication circuit which provides two-way communications between the ECU 20 and each of the electronic controlled relays 30-30n. With such a system, therefore, the number of conductors necessary between the ECU and the electronic controlled relays 30-30n is limited to a single bus 22, which provides greater flexibility for adding and removing ECUs depending on a particular vehicle and devices or accessories being employed, without the need for multiple wiring harnesses and other expensive electrical and related components.

Thus, with the system of the present invention, an improved reduced cost and weight and yet reliable bus communication control system is provided for controlling vehicle devices and accessories that require significant current drain for their operation utilizing the necessary power control relays.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A vehicle control circuit for actuating vehicle electrical devices and accessories in response to an operator input comprising:
a plurality of operator actuated inputs;
a plurality of devices and accessories to be actuated;
a body control module coupled to said operator actuated inputs, said body control module having an output bus for providing addressed control signals uniquely identifying a device or accessory to be actuated in response to the operator input; and
a plurality of electrical control units each coupled to said bus and including an identification circuit and a power control relay, said identification circuit responding to the address uniquely associated with one of said electrical control units and to a control signal from said body control module to actuate an associated relay to provide operating power to a device selected by one of an operator and software.

2. The circuit as defined in claim 1 wherein said body control module provides addressed control signals in a data stream protocol which is one of local interconnect network and controller area network.

3. The circuit as defined in claim 2 wherein said power control relay includes a housing and wherein said identification circuit is positioned within said housing.

4. The circuit as defined in claim 3 wherein said identification circuit includes a microprocessor programmed to identify a unique address associated with one of said identification circuits and provide an output signal in response thereto.

5. The circuit as defined in claim 4 wherein said power control relay includes a relay coil and at least a pair of contacts and wherein said identification circuit further includes a solid state switch coupled to said microprocessor and to said relay coil and responsive to said output signal from said microprocessor to apply current to said relay coil for actuating said relay.

6. The circuit as defined in claim 5 and further including a vehicle battery voltage supply bus and wherein said relay contacts are coupled between said battery supply voltage bus and a device to selectively provide operating power to the device.

7. The circuit as defined in claim 6 wherein said body control module communicates with said electrical control units using local interconnect network protocol signal transmission.

8. The circuit as defined in claim 6 wherein said body control module communicates with said electrical control units using one of a controller area network, a local interconnect, a Flexray, a Ethernet, an OEM specific protocol, and a GM protocol signal transmission.

9. A vehicle control circuit for actuating vehicle electrical devices in response to one of an operator actuated switch or software command comprising:
a plurality of switches for actuation by an operator to control a vehicle device;
a plurality of devices to be actuated;
a control module coupled to said switches, said control module having an output bus for providing addressed control signals uniquely identifying a device or accessory to be actuated in response to the actuation of an associated switch by an operator; and
a plurality of electrical control units each coupled to said bus and including an identification circuit and a power control relay, said identification circuit responding to the address uniquely associated with one of said electrical control units and to a control signal from said control module to actuate an associated relay to provide operating power to a device selected by one of the operator or software.

10. The circuit as defined in claim 9 wherein said control module provides addressed control signals to said bus in a data stream protocol.

11. The circuit as defined in claim 10 wherein said identification circuit includes a microprocessor programmed to identify a unique address associated with one of said identification circuits and provide an output signal in response thereto.

12. The circuit as defined in claim 11 wherein said power control relay includes a relay coil and at least a pair of contacts and wherein said identification circuit further includes a solid state switch coupled to said microprocessor and to said relay coil and responsive to said output signal from said microprocessor to apply current to said relay coil for actuating said relay.

13. The circuit as defined in claim 12 and further including a vehicle battery voltage supply bus and wherein said relay contacts are coupled between said battery supply voltage bus and a device to selectively provide operating power to the device.

14. The circuit as defined in claim 13 wherein said data stream protocol is one of local interconnect network and controller area network.

15. The circuit as defined in claim 14 wherein said power control relay includes a housing and wherein said identification circuit is positioned within said housing.

16. A vehicle control circuit for actuating vehicle electrical devices and accessories in response to an operator actuated switch comprising:
a plurality of switches which are actuated by an operator to actuate a selected vehicle device;
a plurality of devices to be actuated;
a control module coupled to said operator actuated switches, said control module having an output bus for providing addressed control signals uniquely identifying a device or accessory to be actuated in response to the operator input; and
a plurality of electrical control units each having an input coupled to said bus and programmed to respond to an address uniquely associated with one of said electrical control units, each of said electrical control units including a power control relay coupled to a vehicle battery wherein, in response to the receipt of an address associated with the operator selected device to be actuated, the associated relay provides operating power to the device selected by the operator.

17. The circuit as defined in claim 16 wherein said control module provides addressed control signals to said bus in a data stream protocol which is one of local interconnect network and controller area network.

18. The circuit as defined in claim 17 wherein each of said electrical control units includes an application specific integrated circuit programmed to respond to the receipt of an address identifying that electrical control unit to actuate the power control relay of said electrical control unit.

19. The circuit as defined in claim 17 wherein each of said electrical control units includes a microprocessor and a solid state switch, said microprocessor programmed to respond to the receipt of an address identifying that electrical control unit to actuate said switch and the power control relay of said electrical control unit.

20. The circuit as defined in claim 16 wherein each of said electrical control units have an identification circuit for responding to a unique address identifying that control unit and said power control relay includes a housing wherein said identification circuit is positioned within said relay housing.
